(19) United States
(12) Patent Application Publication
(10) Pub. No.: US 2019/0301551 A1
(43) Pub. Date: Oct. 3, 2019

(54) Carrier Pot for a Brake Disc, Brake Disc Arrangement

(71) Applicant: Robert Bosch GmbH, Stuttgart (DE)

(72) Inventors: Martin Stasch, Herrenberg (DE); Wolfgang Huschenhoefer, Asslar (DE); Georg Ketteler, Ludwigsburg (DE); Sven Robert Raisch, Stuttgart (DE); Karim Bahroun, Grossbettlingen (DE)

(21) Appl. No.: 16/316,984

(22) PCT Filed: May 4, 2017
(86) PCT No.: PCT/EP2017/060641

§ 371 Date: Jan. 10, 2019

(30) Foreign Application Priority Data
Jul. 13, 2016 (DE) 10 2016 212 715.2

(51) Int. Cl. F16D 65/12

(52) U.S. Cl. CPC F16D 65/123; F16D 2065/132; F16D 2200/006

(57) ABSTRACT

A carrier pot for a brake disc includes a radially inner hub ring portion for fastening to a wheel hub and a radially outer brake disc ring portion for fastening to the brake disc. The carrier pot is made from a fiber-reinforced plastic which has a plurality of fiber layers. The fibers of at least two adjacent fiber layers are oriented such that the fiber layers run differently with respect to one another.

The invention relates to a carrier pot for a brake disk, having a radially internal hub ring portion for securing to a wheel hub and having a radially external brake disk ring portion for securing to the brake disk.

The invention further relates to a disk brake device for a wheel brake of a vehicle, in particular a motor vehicle, having at least one brake disk and having at least one carrier pot which is connected to the brake disk in a rotationally secure manner.

### PRIOR ART

Carrier pots and brake disk devices of the type mentioned in the introduction are known from the prior art. Different types of brake disk devices for vehicles are known. In the simplest case, the brake disk devices are constructed in one piece and have the brake disk ring and the carrier pot. Such brake disk devices are produced, for example, in one piece from grey cast iron or aluminum. In the case of two-piece brake disk devices, the carrier pot is often produced from a material which is different from that of the brake disk itself in order to adapt the two elements optimally to the stresses, respectively. As a result of the increasing requirements in terms of fuel consumption and durability, attempts are also being made to bring about weight reductions in the brakes of motor vehicles. Accordingly, it is desirable to use materials which are as light as possible.

### STATEMENT OF INVENTION

The carrier pot according to the invention having the features of claim 1 has the advantage that it also ensures a sufficiently high level of durability for uses in the vehicle with a higher drive power with an extremely low weight. In this case, the basic material of the carrier pot comprises plastics material, which results in an advantageously low weight of the carrier pot. A plurality of fibers extend through the plastics material and impart the necessary rigidity and durability to the carrier pot. In this case, there is provision for the carrier pot to be produced from a particularly high-temperature-resistant fiber plastics composite which has a plurality of fiber layers each having a large number of fibers, wherein the fibers of at least two adjacent layers are orientated differently relative to each other. As a result of the differently orientated fiber layers, a high mechanical durability of the carrier pot is ensured with a low weight. By a high-temperature-resistant plastics material being selected, the dimensional stability of the component or carrier pot and consequently the optimum force introduction into the fibers are also ensured at temperatures above 150° C. The production of fiber plastics composite materials has further become more cost-effective in recent years so that the advantageous configuration of the carrier pot does not result in significant cost disadvantages.

According to a preferred development of the invention, there is provision for the fibers of the at least two layers to be orientated at least substantially perpendicularly to each other. As a result of the perpendicular orientation, it is ensured that the carrier pot ensures the desired durability of the material composite/fiber plastics composite both when it is loaded in terms of pressure and when it is loaded in terms of tension, that is to say, in the event of loading of the carrier pot in both rotation directions as a result of a small thrust loading of the plastics material. Preferably, the layers are constructed symmetrically relative to each other and consequently the angular offset of two adjacent layers is small. As a result of the described structure, induced stresses in the composite are minimized, the loading of the plastics material embedding the fibers is reduced and a high durability of the composite is ensured.

According to a preferred development of the invention, there is provision for the hub ring portion and/or the brake disk ring portion to have at least one securing location for securing to the wheel hub or the brake disk, wherein there is provided at least one additional support fiber which surrounds the respective securing location at least substantially annularly. Consequently, the carrier pot can be connected at the securing location(s) to the brake disk or the wheel hub or rim of a wheel of the vehicle. The respective securing location can be constructed, for example, as a securing opening or as, for example, a stud-like securing projection. The respective securing location is at least substantially annularly surrounded by the additional support fiber. The durability in the region of the securing location is thereby further increased in a selective manner.

Preferably, the support fiber surrounds the respective securing location at least substantially in the manner of a circular ring in order to ensure a uniform load behavior or a uniform force distribution. Furthermore, there is preferably provision for the support fiber to extend, in particular axially, through the layer structure of the fiber composite plastics material during the enclosure of the securing location so that a large portion of the length thereof is perpendicular to the orientation of the fiber layers. In this manner, the composite layers of the carrier pot are reinforced under high loads in the region of the respective securing location by the described axial reinforcement in an ideal manner against delamination and consequently the durability of the respective securing location is improved.

Furthermore, there is preferably provision for the at least one support fiber to surround a plurality of securing locations annularly. Consequently, the support fiber extends annularly around a securing location, from one securing location as far as the next securing location, and also around the next securing location in an annular manner. In this manner, a plurality of securing locations are connected to each other by the support fiber and supported separately, respectively.

Particularly preferably, there is provision for the support fiber to annularly surround alternately a securing location of the brake disk portion and a securing location of the wheel hub portion. Therefore, the support fiber extends between two securing locations in a radially outward direction or in a radially inward direction. Preferably, the securing locations are arranged in this case so as to be offset relative to each other when viewed in a peripheral direction so that the support fiber does not extend precisely in a radially inward direction or in a radially outward direction, but instead extends along a force flow line. The carrier pot is thereby reinforced in a loading direction. In a particularly preferred manner, the support fiber extends over the carrier pot in such a manner that it surrounds all the securing locations at least once in an annular manner. A particularly high level of durability is thereby ensured.

According to a preferred development of the invention, there is provision for the support fiber to be arranged so as to extend between the securing locations along a loading path of the carrier pot so that during operation it is stressed at least substantially only in terms of tension. The loading path is the force path of the loading which may be anticipated and which is produced during operation of the carrier pot in a wheel brake. In this case, the respective loading path extends from a securing location of the wheel hub portion to a securing location of the brake disk portion and accordingly results from the arrangement of the securing locations and the formation of the carrier pot. The loading path can be calculated, for example, wherein in particular a loading path is produced between each securing location which extends radially inwardly in a peripheral direction and which is located radially outwardly. Preferably, the support fiber extends between an internal securing location and an adjacent external securing location which is located so as to be offset relative thereto in a peripheral direction, as already explained above, so that a uniform pattern is produced.

In this case, there is in particular provision for two support fibers or two support fiber portions of one support fiber to intersect in a radial region between the brake disk ring portion and the wheel hub ring portion. It is thereby ensured that the brake pot can be identically loaded in both rotation directions.

In a particularly preferable manner, there is provision for the support fiber to be stitched into the fiber plastics composite. The support fiber can thereby selectively obtain the desired form or the desired extent. The stitching can be carried out with little consumption of time and in a precise manner so that a high level of quality can be achieved. As a result of the stitching of the support fiber, in particular the above-described extent of the support fiber axially through the fiber plastics composite is achieved, that is to say, the introduction of the support fiber composite plastics material through the support fiber. In particular, the stitching is carried out in such a manner that the support fiber is partially stitched on the fiber plastics composite, in particular in the region of the securing locations. The support fiber is therefore stitched on the fiber composite active material by the stitching preferably in addition to an introduction into the fiber composite plastics material in the region of the securing locations or alternatively only on the fiber composite active material. It is particularly advantageous to have a substantially elongate orientation of the support fiber between the particularly adjacent securing locations or the securing locations which follow each other in the row of the support fiber, which ensures an optimum force flow through the at least one support fiber.

The brake disk device according to the invention having the features of claim 10 is distinguished by the construction according to the invention of the carrier pot. The advantages already mentioned are thereby afforded.

Other advantages and preferred features and feature combinations result in particular from what has been described above and the claims.

The invention is intended to be explained in greater detail below with reference to the drawings, in which:

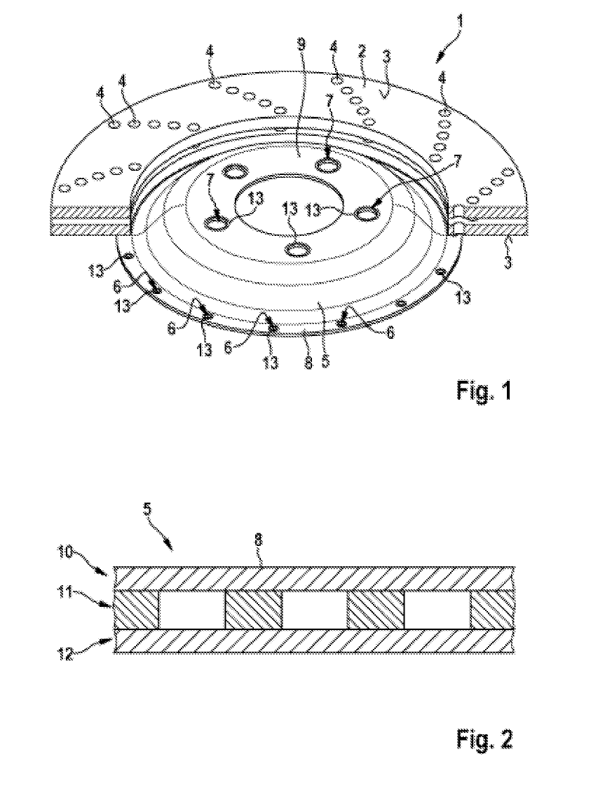

FIG. 1 is a perspective cross-section of a brake disk device,

FIG. 2 is a cross-section of a carrier pot of the brake disk device,

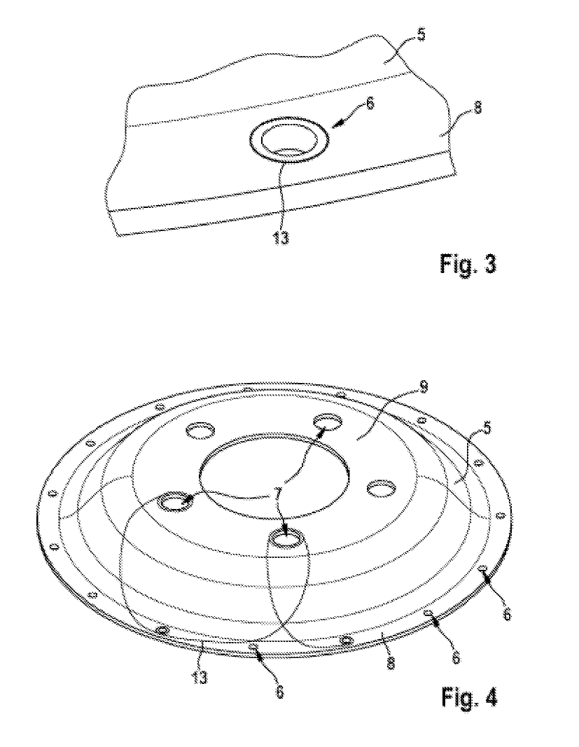

FIG. 3 is an enlarged view of a detail of the carrier pot and

FIG. 4 is a simplified perspective view of the carrier pot.

FIG. 1 is a perspective cross-section of a brake disk device 1 for a wheel brake of a motor vehicle. A wheel brake in conventional motor vehicles generally has a brake caliper, on which brake linings are arranged, between which a brake disk is guided. If the brake linings are moved in the direction of the brake disk, it is clamped between them and a braking force or a braking torque is thereby produced.

To this end, the brake disk 2 of the brake disk device 1 as shown in FIG. 1 is advantageously constructed in a point-symmetrical manner relative to the axis and in a circular manner. At the axial end sides thereof, it has brake faces 3 which cooperate with the brake linings of the wheel brake. The brake linings are constructed in the manner of a circular ring and have in this case a plurality of ventilation openings 4 for cooling the brake disk device 1 during operation. The cooling is necessary because brake disks of a braking operation are subjected to high mechanical and thermal loads. The cause of this is that, during the deceleration of the vehicle which has the brake disk device, practically the entire kinetic energy stored in the vehicle has to be converted into heat. Since the brake disk 2 in the vehicle constitutes a non-cushioned rotating mass, there are efforts to reduce the mass of the brake disk 2.

The brake disk 2 is securely connected to a carrier pot 5 which can be secured to a wheel hub or to a rim of a wheel of the vehicle in order to transmit the braking forces to the wheel. In conventional brake disk devices, the carrier pot 5 and the brake disk 2 are produced integrally with each other, for example, by a grey cast iron casting method. In order to reduce the mass of the brake disk device 1, it is now also known to construct the carrier pot 5 and brake disk 2 separately from each other in order to allow advantageous material combinations for the carrier pot 5 and the brake disk 2, in particular for the friction ring of the brake disk 2. In this case, it is also known to use, in addition to grey cast iron, aluminum, steel or silicon carbide ceramic materials. The carrier pot 5 and brake disk 2 are then connected to each other by extremely different connection methods, such as, for example, bolting, screwing or casting.

In the brake disk device 1 shown in FIG. 1, the carrier pot 5 has a plurality of securing locations 6 and 7 which are used to secure the carrier pot 5 to the brake disk 2 and to the wheel hub. To this end, the securing locations 6 are constructed on a radially external brake disk ring portion 8 and are arranged so as to be distributed uniformly over the periphery of the carrier pot 5. The securing locations 7 are arranged so as to be distributed uniformly over the periphery on a radially internal wheel hub ring portion 9 of the carrier pot 5. The connection with respect to the brake disk 2 is produced at the securing locations 6 and the connection with respect to the wheel hub is produced at the securing locations 7.

According to the present embodiment, the securing locations 6 are constructed as securing openings which are used to screw, bolt or rivet the carrier pot 5 to the wheel hub or the brake disk 2, respectively. Alternatively, at least some of the securing locations and/or 7 can also be constructed as particularly stud-like projections on the carrier pot 5. The securing locations 6 can also be constructed as pockets, in which a separate securing bolt which axially projects from the carrier pot 5 is cast or formed. The securing locations 6 are preferably constructed in such a manner that they are also protected at high thermal loads by the ventilation holes 4 or similar cooling devices, such as, for example, air gaps of the brake disk, or by using thermally insulating materials in the region of the securing locations 6, such as, for example, ceramic bushes or ceramic coatings.

According to the present embodiment, the carrier pot 5 is produced from a fiber plastics composite which ensures a sufficiently high mechanical and thermal durability with particularly low weight.

In this regard, FIG. 2 is a simplified cross-section through the brake disk ring portion 8 of the carrier pot 5. The fiber composite plastics material has a plurality of layers 10, 11, 12 of identically orientated or extending fibers, wherein the fibers of the adjacent layers 10, 11, 12 are orientated differently, in this case perpendicularly, relative to each other. A high strength of the carrier pot 5 is thereby ensured so that high braking forces can also be transmitted by the carrier pot 5 in both directions of rotation.

FIG. 3 is an enlarged detailed view of the carrier pot 5 in the region of one of the securing locations 6. In addition to the fibers of the fiber plastics material composite of the carrier pot 5, it has a support fiber 13 which annularly surrounds the securing location 6 or the securing opening. The support fiber 13 is stitched into the material of the fiber plastics material composite and comprises in particular a plurality of fiber strands which have been woven with each other by the stitching. As a result of the annular configuration of the support fiber 13, the carrier pot 5 is further reinforced and supported in the region of the securing location 6 so that the durability of the carrier pot 5 is substantially increased by a minimal weight increase by the support fiber 13. Advantageously, a corresponding support fiber 13 is associated with each securing location 6. A support fiber 13 which annularly surrounds the respective securing location 7 is also associated with the securing locations 7. The support fiber 13 is advantageously fitted to the carrier pot 5 by a stitching operation so that it partially extends in particular axially through the layer structure of the fiber plastics material composite and is consequently located perpendicularly to the orientation of the fiber layers 10, 11, 12 over a large portion of the length thereof. In this manner, the composite layers 10, 11, 12 are reinforced in an ideal manner against delamination in the event of high loads in the region of the securing location 6, 7 by the axial reinforcement and consequently the durability of the securing locations 6, 7 is improved. In particular, the respective support fiber 13 is partially stitched on the fiber plastics material composite or carrier pot 5 in the region of the securing locations in order to even further increase the durability.

As a result of the support fibers 13, consequently, the securing locations 6 and 7 the carrier pot 5 are advantageously supported and the durability of the carrier pot 5 and the brake disk device 1 is thereby generally increased.

FIG. 4 shows an advantageous development of the carrier pot 5, according to which a support fiber 13 annularly surrounds not only one securing location 6 or 7 but also a plurality of securing locations 6 and 7, respectively. To this end, the support fiber 13 is stitched on the carrier pot 5 in such a manner that it annularly surrounds alternately a securing location 7 and a securing location 6 which is adjacent or spaced apart in a peripheral direction and which extends between the securing locations 6 and 7 preferably at least substantially in elongate form in a radially outward direction or in a radially inward direction between the securing locations 6, 7. The loop-like extent of the support fiber 13 shown by way of example in FIG. 4 is thereby produced. In this case, there is in particular provision for the support fiber portion 13 to be arranged so as to extend between the securing locations 6, 7 along a loading path of the carrier pot 5. The loading path is particularly calculated and constitutes the force flow through the carrier pot 5 during a braking operation. As a result of the advantageous configuration, it is possible for high braking forces to be able to be produced by the carrier pot 5 or to be transmitted from the brake disk 2 to the respective wheel. As a result of the extent of the support fibers 13 shown in FIG. 4, it is possible for support fiber portions to intersect between the securing locations 6 and 7 so that the carrier pot 5 is constructed to be strengthened in both rotation directions or durable as a result of the support fiber 13. FIG. 4 shows a portion of the support fiber 13 for the purposes of visualization. Advantageously, the support fiber 13 extends over the entire periphery of the carrier pot 5 so that it annularly surrounds at least once at least all the securing locations 7 and at least every other securing location 6. By providing additional such support fibers, all the securing locations 6 and 7 can be supported at least once, wherein the support fibers 13 then also intersect once or repeatedly in the radial region between the securing locations 7 and the securing locations 6.

As a result of the advantageous construction, both a high level of rigidity and strength of the carrier pot is ensured in the fiber direction under tensile loading with little rigidity of the surrounding plastics matrix and of the fibers of the fiber layers 10, 11, 12 transversely relative to the fiber direction, or pressure loading.

By using the fiber composite plastics material for the carrier pot 5 with in particular quasi-isotropic properties for securing the direction of rotation of the independent strength of the carrier pot 5, the mentioned advantages are achieved. The material of the support fibers 13 and the fibers in the layers 10, 11, and of the plastics material are selected in accordance with the mechanical and thermal requirements. By using the fiber reinforcement which is suitable for laden travel as a result of the support fibers 13 which ideally extend in such a manner that they are loaded only in terms of tension, substantially higher loads can be achieved with little material application. Depending on the selection of the fiber reinforcement which is suitable for laden travel as a result of the support fibers 13, the strength of the carrier pot 5 can also be adjusted in accordance with the direction of rotation.

1. A carrier pot for a brake disk, comprising:
a radially internal hub ring portion configured to be secured to a wheel hub;
a radially external brake disk ring portion configured to be secured to the brake disk,
wherein the carrier pot includes a fiber plastics composite having a plurality of fiber layers, and
wherein fibers of at least two adjacent fiber layers of the plurality of fiber layers are orientated so as to extend differently relative to each other.

2. The carrier pot as claimed in claim 1, wherein the fibers of the at least two adjacent fiber layers are orientated so as to extend at least substantially perpendicularly to each other.

3. The carrier pot as claimed in claim 1, wherein:
the radially internal hub ring portion and/or the radially external brake disk ring portion has at least one securing location configured to be secured to the wheel hub or the brake disk; and
at least one additional support fiber surrounds the at least one securing location at least substantially annularly.

4. The carrier pot as claimed in claim 3, wherein the at least one additional support fiber surrounds the at least one securing location at least substantially as a circular ring.

5. The carrier pot as claimed in claim 3, wherein:
the at least one securing location is a plurality of securing locations; and
the at least one additional support fiber surrounds the plurality of securing locations annularly.

6. The carrier pot as claimed in claim 3, wherein the at least one additional support fiber annularly surrounds alternately a securing location of the at least one securing location of the brake disk ring portion and a securing location of the at least one securing location of the wheel hub ring portion.

7. The carrier pot as claimed in claim 3, wherein:
the at least one securing location is a plurality of securing locations; and
the at least one additional support fiber is arranged so as to extend between two securing locations of the plurality of securing locations along a loading path of the carrier pot.

8. The carrier pot as claimed in claim 3, wherein two support fibers or two support fiber portions of the at least one additional support fiber intersect in a radial region between the brake disk ring portion and the wheel hub ring portion.

9. The carrier pot as claimed in claim 3, wherein the at least one additional support fiber is stitched into the fiber plastics composite.

10. A brake disk device for a wheel brake of a vehicle, comprising:
at least one brake disk; and
at least one carrier pot connected to the brake disk in a rotationally secure manner, the carrier pot including:
a radially internal hub ring portion configured to be secured to a wheel hub; and
a radially external brake disk ring portion configured to be secured to the brake disk,
wherein the carrier pot includes a fiber plastics composite having a plurality of fiber layers, and
wherein fibers of at least two adjacent fiber layers of the plurality of fiber layers are orientated so as to extend differently relative to each other.
